(19) United States
(12) Patent Application Publication
(10) Pub. No.: US 2008/0246821 A1
(43) Pub. Date: Oct. 9, 2008

(54) Ink Jet Write Head

(76) Inventor: Manfred Pauly, Muhltal (DE)

Correspondence Address: WRB-IP LLP, 1217 KING STREET, ALEXANDRIA, VA, 22314, US

(21) Appl. No.: 11/568,987

(22) PCT Filed: Apr. 30, 2005
(86) PCT No.: PCT/EP05/04718

§ 371 Date: May 30, 2008

(30) Foreign Application Priority Data
May 11, 2004 (DE) 10 2004 023 121.4
Sep. 9, 2004 (EP) PCT/EP2004/010042

(51) Int. Cl. B41J 2/045

(52) U.S. Cl. 347/68

(57) ABSTRACT

The invention relates to an ink jet write head which comprises a pressurized ink compartment (2), at least one ink nozzle (5), obturated by a movable valve body (6), and a piezoelectric valve actuation element (10). Said element drives the valve body (6) to perform lifting movements and is electrically connected to a control device (16). A piezoelectric element (14, 15) is applied to both sides of a bending strip (11) which is linked with the valve body (16) in a driven manner. The piezoelectric elements are especially planar and can be electrically controlled by the control device (16) independently of each other. The bending strip (11) consists of a spring steel sheet and is bent to such an extent that a strip limb (11a) at the valve end extends at an angle to the stroke direction of the valve body (6) and that a longitudinal section (11b) of the bending strip (11) is bent relative thereto. The valve proximal end (12) of the bending strip (11) is adjustably linked with the valve body (6) via a drawbar (9) or via a drawrope comprising an adjusting nut (13).

The invention relates to an ink jet write head with a pressurized ink chamber with at least one ink jet, which is obturated by a movable valve body, with a piezoelectric valve actuation element that performs bending motions, which actuates the valve body to perform lifting movements and is connected electrically to a control device.

Such ink jet write heads are used to print script characters and numbers onto surfaces that are moved past them. Customarily, several ink jets, which are activated at will by means of a control unit so as to open the controlled jet for a brief period in each case, are provided in an ink chamber. Under the influence of the prevailing pressure within the ink chamber, a brief jet of ink, which generates a point upon the surface to be printed, is propelled from the ink jet.

In the case of one known ink jet write head (EP 0 445 137), folding magnets are provided as valve actuation elements, whose anchors, in each case, are connected so as to activate the allocated valve bodies. In the process, the mass formed essentially by the folding magnet's anchor must be accelerated and delayed with every valve actuation procedure. The requisite energy for doing so limits the potential working speed of the valve actuation device.

In the case of a known ink jet write head of the type alluded to at the outset (DE 1 952 880 A), the use of piezoelectric valve actuation devices for the purpose of increasing working speed was suggested. In this case, however, there is the difficulty that the piezoelectric elements used in that instance, because of the manner of their construction as bending strips or rods that undergo longitudinal changes, do not meet the practical requirements at greater writing speeds and therefore could not be used in practice after the manner described in the printed document.

It is the task of the invention, therefore, to embody an ink jet write head of the type alluded to at the outset in such a manner that it can be operated without interruption, even at the working speeds that are required in practice.

This task is resolved according to the invention by virtue of the fact that the valve actuation element exhibits a bending strip at the end, on the same side as the valve, which is connected to the valve body so as to actuate it, from which a piezoelectric element is applied on either side, in each case, and that both piezoelectric elements may be controlled separately, electrically, by means of the activating device.

Piezoelectric elements that are planar, especially those on a film basis, are used, preferably.

In MFC piezoelectric elements (macro-fiber composite piezoelectric elements), which are known, for example, from WO 01/33648 A1, and commercially available, high-power piezoelectric elements are, indeed, available, but, because of the manner of their construction, they cannot be used directly to actuate the valves on ink jet write heads.

Only by means of the connection with a bending strip, on which, for example, two such MFC piezoelectric elements (or other piezoelectric elements on a film or strip basis) are applied on either side, does a valve actuating element arise that requires very little space and renders sufficiently high power and working speed possible for use in an ink jet write head.

The capacity to activate the two piezoelectric elements separately renders it possible to control the valve body in both directions, namely the opening motion and the closing motion, in a purposeful manner, so that both motions can be performed very quickly and with sufficient force. Only by these means is an exact actuation of the valve, such as is necessary for an ink jet write head, possible.

According to a preferred embodiment of the invention, provision is made for the bending strip to be a strip of sheet metal, preferably sheet spring steel. In this embodiment, the bending strip affords both piezoelectric elements sufficient rigidity, on the one hand; on the other hand, it is readily flexible to a sufficient degree to perform the rapid valve actuation motions.

In a further configuration of the thought behind the invention, provision is made, to particularly good advantage, for the bending strip to be bent such that one limb of the strip, on the same side as the valve, extends oblique to the valve body's direction of stroke and a longitudinal section of the bending strip is bent at an angle relative thereto.

This embodiment, which is bent at an angle, in which the limb of the strip on the same side as the valve and the longitudinal section of the strip are connected to each other to good effect by means of an arc-shaped section, renders an embodiment of the ink jet write head possible that is particularly space-saving on the one hand; on the other hand, by these means, the provision of a high actuating force and a high actuating stroke in conjunction with very high working speed, is simultaneously rendered possible.

In a particularly preferred embodiment form of the invention, provision is made so that the bending strip that bears the piezoelectric elements, is seated in its central area so as to swivel around an axis of pivot that extends oblique to its plane of motion and that the end of it that is far removed from the valve is firmly held to the frame. In the process, what is accomplished, in a particularly space-saving manner, is that the deformation of the bending strip that is caused by the piezoelectric elements can be transformed, in a particularly effective manner, into an activating movement of the valve.

Additional advantageous embodiments of the thought behind the invention are the subject matter of additional dependent claims.

The invention is elucidated in greater detail in what follows by virtue of embodiments that are depicted in the drawings.

FIG. 1 shows an ink jet write head in a schematic manner of representation.

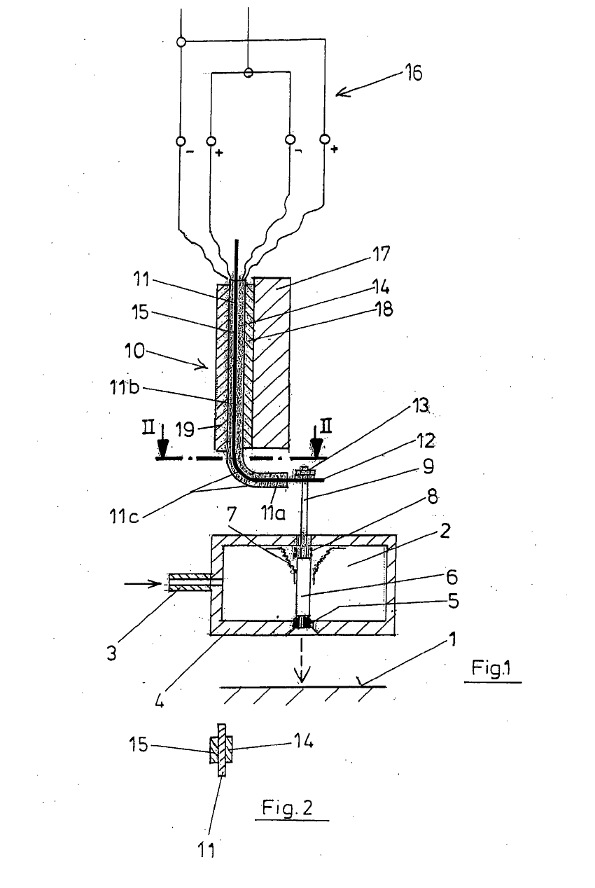

FIG. 2 shows an enlarged partial section along the line II-II in FIG. 1 and

FIG. 3, in a representation corresponding to FIG. 1, shows another derived embodiment form of an ink jet write head, and

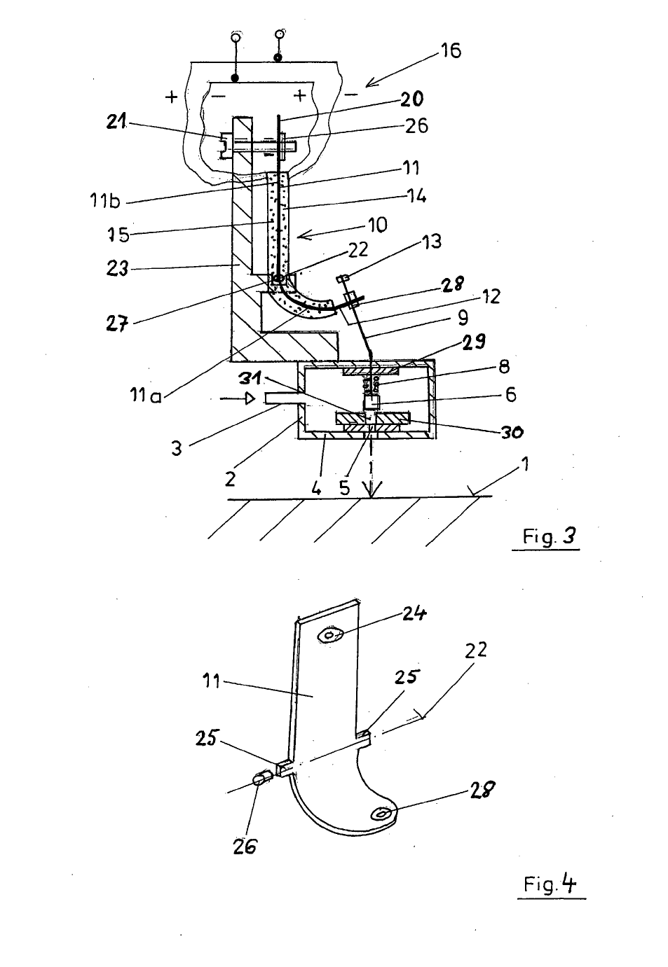

FIG. 4, in a spatial mode of representation, shows the bending strip of the ink jet write head according to FIG. 3.

The ink jet write head, which is depicted schematically in a section in FIG. 1, serves the purpose of printing written characters and numbers on a surface 1, which is merely indicated in FIG. 1, while this surface 1 is moved along the ink jet write head. To this end, the ink jet write head exhibits a pressurized ink chamber 2, filled with writing ink, which is supplied with ink by way of an ink line 3. Several ink jets 5 are arranged in the bottom wall 4 of ink chamber 2, though only one of these ink jets 5 is represented in FIG. 1.

Each ink jet 5 is obturated by a valve body 6, which may be activated to perform controlled lifting movements. The valve body 6, which is obturated toward the inner wall of ink chamber 2 by means of a flexible seal 7 and is pressed by means of a compression spring 8 into the valve's closed position, is connected to a valve actuation element 10 via a drawbar 9, which is conducted out of the ink chamber 2. In lieu of the flexible seal 7, a lead through seal with corresponding seal material can also be used.

Similarly, it is possible, and in some instances advantageous, to replace the drawbar 9 with a thin draw rope or spun strand.

The valve actuation element 10 exhibits a bending strip 11, which is, in the case of the embodiment that is depicted, a sheet metal strip made of spring steel. The end 12 of bending strip 11, which is on the same side as the valve, is connected to the drawbar 9 by way of an adjusting nut 13.

On the bending strip 11, on either side, in each case, an elongated piezoelectric element, 14, 15, is applied in the form of a strip. Both piezoelectric elements 14, 15 are connected electrically to an electric control device 16 in such a manner that both piezoelectric elements 14, 15 can be controlled separately by the control device 16 in order to perform changes in length in opposite directions.

In the case of the embodiment depicted, the bending strip 11, with the piezoelectric elements 14, 15 applied to it, is curved in such a way that a strip limb 11a on the same side as the valve extends obliquely to direction of stroke of valve body 6 and a longitudinal strip section 11b of the bending strip 11 is bent relative thereto.

The strip limb 11a on the same side as the valve and the longitudinal strip section 11b are connected to each other via an arc-shaped section 11c. The longitudinal strip section 11b is accommodated in a securing block 17 between insulation and attachment plates 18, 19 that can be formed, in a recess of the securing block 17.

If both piezoelectric elements 14, 15 are controlled by the electric control device 16 by means of corresponding opposite electrical polarity and therefore undertake opposite changes of length, the bending strip 11 is bent so that its end 12, which is on the same side as the valve, performs controlled upward or downward movements. By these means, an opening and closing stroke is generated for the valve body 6.

By way of deviation from the embodiment form shown, the bending sheet 11 [sic-not strip], with the piezoelectric elements 14 and 15 applied to it, can also be embodied so as to be straight.

The bending strip 11 and the piezoelectric elements, 14, 15, applied to it together constitute a dimorphic bending element.

In the embodiment according to FIGS. 3 and 4, the same reference symbols are used as in FIG. 1 for corresponding parts. The end 20 of the bending strip 11 that is remote from the valve is held securely to the frame, in such a way, though its position may be altered in the direction of pivot by means of an adjustment screw 21.

The embodiment according to FIGS. 4 and 5 differs from the embodiment according to FIG. 1 essentially by virtue of the fact that the bending strip 11, which bears the piezoelectric elements 14, 15, is seated so that it may be swiveled, in its central area, around an axis of pivot 22, which, in the case of the depicted embodiment, lies in the plane of bending strip 11 and extends oblique to its plane of motion, which coincides with the plane of symbols in FIG. 4. One speaks of a seat in the “central area” of the bending strip 11 within this context because the bending strip 11 exhibits a longitudinal strip section, 11b, which extends between the axis of pivot 22 and the end that is remote from the valve 20, and a curved limb of the strip, 11a, which extends between the axis of pivot 22 and the end that is on the same side as the valve, 12.

In the case of the embodiment depicted, the longitudinal strip section, 11b extends approximately in the direction of valve actuation. The limb of the strip on the same side as the valve 11a, is, by contrast, curved or angled away. In the embodiment according to FIG. 3, the curvature of the limb of the strip 11a extends across an arc of approximately 90°. Other curvatures and extensions of the limb of the strip across segments of arc that may be selected across a wide range are suitable or to good purpose for [a] particular embodiment.

The bending strip 11 is seated in a holder 23 that is connected to ink chamber 2, at which the adjustment screw 21 also engages. The adjustment screw 21 may be turned on the holder 23 and is engaged with press nut 24, which is applied at the free end 23 [sic—not holder—Trans.] of bending strip 11.

As depicted in FIG. 5, [not provided—Trans.] the seating of bending strip 11 for the purpose of forming the axis of pivot 22 is undertaken in such a manner that two laterally protruding brackets 25 on opposite sides of bending strip 11 each bear a tubular sleeve 26, each of which are [sic] inserted into a bearing recess 27 on the holder 23.

The end 12 of bending strip 11 on the same side as the valve bears an adjustment pipe nut 28, by means of which the drawbar 9, which is embodied here as a draw wire, extends. The drawbar 9, at the end that is accommodated in the adjustment pipe nut 28, is supplied with threading and it bears the adjustment nut 13. Thus, a repositioning of the drawbar 9 at the end 12 of bending strip 11 on the same side as the valve is rendered possible.

The drawbar, 9, which is embodied as a draw wire, extends into the ink chamber 2 through an elastic sealing plate 29, and is connected at its end to the valve body 6, which is pressed onto an elastic sealing plate 30, which exhibits a communicating borehole 31, by means of the compression spring 8. The ink jet 5 is arranged beneath the borehole 31.

When both piezoelectric elements, 14, 15 are controlled by the electric control device 16 by means of corresponding opposite electric polarity and therefore perform opposite changes of length, the entire bending strip 11 is bent in such a way that its end 12, which is on the same side as the valve, performs controlled lifting motions that are transferred to the valve body 6.

1. An ink jet write head with a pressurized ink chamber having at least one ink jet that is obturated by a movable valve body, with a piezoelectric valve actuation element that is electrically connected to a control device, that activates the valve body to perform lifting motions, which actuation element performs bending motions, wherein the valve actuation element exhibits a bending strip that is in an activating connection with the valve body at its end, which is remote from the valve, to which, on either side, a piezoelectric element is applied in each case, and that both piezoelectric elements may be electrically controlled separately by means of the control device.

2. An ink jet write head according to claim 1, wherein the bending strip is a sheet metal strip.

3. An ink jet write head according to claim 2, wherein the bending strip consists of sheet spring steel.

4. An ink jet write head according to claim 1, wherein the end of bending strip that is on the same side as the valve is connected to the valve body by way of a drawbar a draw wire, or a draw rope.

5. An ink jet write head according to claim 4, wherein the drawbar, the draw wire, or draw rope is connected to the bending strip in such a manner that its position can be adjusted by way of an adjustment nut.

6. An ink jet write head according to claim 1, wherein the bending strip is bent in such a manner that a strip limb that is on the same side as the valve extends oblique to the direction of stroke of the valve body and a longitudinal strip section of the strip is bent relative thereto.

7. An ink jet write head according to claim 6, wherein the strip limb on the same side as the valve and the longitudinal strip section are connected to each other by way of an arc-shaped section.

8. An ink jet write head according to claim 6, wherein the longitudinal strip section is accommodated in a securing block.

9. An ink jet write head according to claim 8, wherein longitudinal strip section is accommodated between workable insulation and attachment plates in a recess of the securing block.

10. An ink jet write head according to claim 1, wherein the bending strip is straight.

11. An ink jet write head according to claim 1, wherein the bending strip is curved in the form of an arc.

12. An ink jet write head according to claim 4, wherein the bending strip, which bears the piezoelectric elements is seated in its central area so as to swivel around an axis of pivot that extends oblique to its plane of motion and that its end, which is remote from the valve, is held securely to the frame.

13. An ink jet write head according to claim 12, wherein the end of the bending strip that is remote from the valve is held so that its position may be adjusted in the direction of pivot.

14. An ink jet write head according to claim 13, wherein the end of the bending strip that is remote from the valve may be repositioned by means of an adjustment screw.

15. An ink jet write head according to claim 12, wherein the bending strip exhibits a longitudinal section of the strip that extends between the axis of pivot and the end that is remote from the valve, and a curved limb of the strip that extends between the axis of pivot and the end that is on the same side as the valve.

16. An ink jet write head according to claim 15, wherein the longitudinal section of the strip extends approximately in the direction of the valve actuation device and the limb of the strip that is on the same side as the valve is bent or positioned at an angle relative thereto.

17. An ink jet write head according to claim 12, wherein the bending strip is seated in a holder that is connected to the ink chamber

18. An ink jet write head according to claim 1, wherein planar piezoelectric elements are used.
